(19) United States
(12) Patent Application Publication
(10) Pub. No.: US 2005/0067172 A1
(43) Pub. Date: Mar. 31, 2005

(54) System, apparatus and method for fire suppression

(76) Inventor: Glen P. Belvis, Naperville, IL (US)

Correspondence Address: Glen P. Belvis, 3623 Shakespeare Lane, Naperville, IL, 60564, US

(21) Appl. No.: 10/672,629

(22) Filed: Sep. 26, 2003

(51) Int. Cl. A62C 25/00

(52) U.S. Cl. 169/68; 239/650

(57) ABSTRACT

There is provided a system and method that uses solid CO₂ for the purposes of fire suppression. In particular, there is provided a method of preventing fires by covering an area, a structure or an item to be protected with a layer of solid CO₂. There is also provided a fire fighting and prevention apparatus that comprises a vehicle, a source of CO₂, a solid CO₂ generating assembly and a solid CO₂ distributor. This vehicle can be position to cover or fill a structure that is already on fire with solid CO₂ to put out the fire, or cover or fill a structure that is in the risk of catching fire to prevent that structure from catching fire.

### FIELD OF THE INVENTION

This invention relates to the use of sold carbon dioxide (CO₂) in systems, apparatus and methods to prevent, suppress and inhibit fires.

### BACKGROUND OF THE INVENTION

There are many was in which fire can be suppressed. Most common among these is through the use of water with conventional fire fighting equipment such as a fire truck. Additionally, chemical or solid suppressants, such as those used in hand held fire extinguishers, gaseous CO₂, which is also used in hand held fire extinguishers, and foams have been used to put out fires. These systems each have their disadvantages. For example, they can at times cause substantial damage to the property themselves. Water damage, from the water used to extinguish a structure fire, can be extensive and at times greater than the damage cause by the fire itself. Chemical and foam suppressants can leave residues that damage equipment, structures and the contents of structures. These agents are also quite expensive. Thus, these agents are principally intending to put out an existing fire and are not readily used to prevent a fire or protect a structure from fire.

The present invention provides an approach to the suppression and prevention of fires that is unique and not previously know. The present invention uses solid CO2 as both a fire prevention and fire extinguishing tool.

### SUMMARY OF THE INVENTION

This invention relates to the use of solid CO₂ for the purposes of fire suppression. In particular this invention generally relates to the method of preventing fires by covering an area, a structure or an item to be protected with a layer of solid CO₂. Additionally, a structure can be field with sold ₂ to protect the structure from fire. This invention further relates to a fire fighting and prevention apparatus that comprises a vehicle, a source of CO₂, a solid ₂ generating assembly and a solid CO₂ distributor. This vehicle can be position to cover or fill a structure that is already on fire with solid CO₂ to put out the fire, or cover or fill a structure that is in the risk of catching fire to prevent that structure from catching fire.

### DRAWINGS

FIG. 1—Is a plan view of a mobile fire-fighting, prevention system employing the teachings of the present invention.

FIG. 2—Is a block diagram of a solid CO₂ pellet generating assembly that may be employed in the present invention.

FIG. 3—Is a plan view of a stationary fire-fighting, prevention system employing the teachings of the present invention.

FIG. 4—Is a phase diagram for CO₂ showing the relationship between temperature pressure and state of CO₂.

### DETAILED DESCRIPTION OF PRESENTLY PREFERRED EMBODIMENTS OF THE INVENTION

This invention relates to the use of sold CO₂, which has also been referred to as dry ice, to suppress, extinguish, control and otherwise put out or prevent fires. CO₂ (carbon dioxide) at standard temperature and pressure exists as a gas. Solid CO₂ is also commonly known as dry ice. Dry ice is frozen carbon dioxide. At standard atmospheric pressure dry ice has a surface temperature of about −109.3 degrees F. (−78.5 degrees C.). It has been traditionally known and used as a refrigerate for shipping items, for amusement purposes such as to make fog for parties and nightclubs and it has also more recently been used to clean articles.

As CO₂ is cooled it changes to a solid or liquid state as shown in the phase diagram of FIG. 4. In FIG. 4, phase 70 represents the vapor phase, phase 71 represents the solid phase, and phase 72 represents the liquid phase. Thus, CO₂ can be stored as a liquid in high-pressure tanks. If the pressure from those tanks is release through a small orifice or opening the pressure drop will cause the liquid CO₂ to cool and change states into a solid. When sold CO₂ warms, at atmospheric pressure it changes directly from a solid to a gas. This transition is known as sublimation. This feature of sublimation plays an important role in one of the benefits that may be obtainable from the present invention. Because solid CO₂ changes directly from a solid to a gas there is no residue left behind. Thus, if solid CO₂ is used to stop a house fire there would be no residue left in the house from the CO₂, it would have changed to a gas and dissipated into the atmosphere. This should be compared to prior art techniques of using water to fight a house fire. In using water after the fire has been extinguished the water remains behind in the house and causes at times substantial damage to the house and its contents.

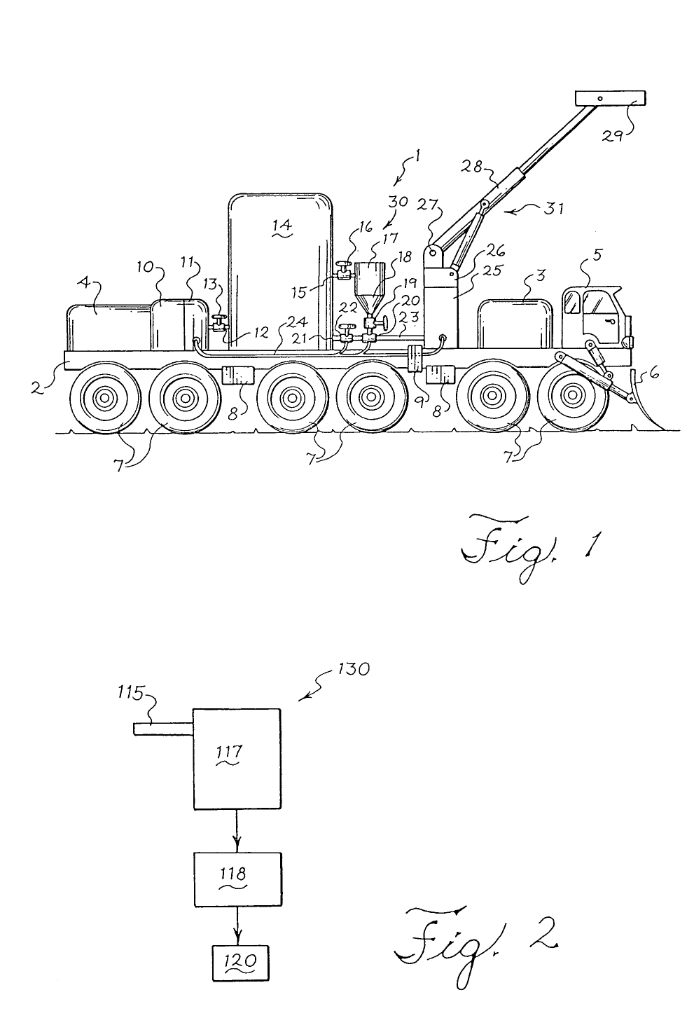

FIG. 1 is an embodiment of mobile firefighting and fire prevention system that employees the teachings of the present invention. This embodiment of the present invention is shown by way of example to illustrate an implementation of the present invention and should not be used to and does not limit the scope of the present invention. This embodiment has many applications in the extinguishment and prevention of fires. By way of illustration and without limitation on other uses, this embodiment can be used to fight wild fires such as brush and forest fires by directly applying solid CO₂ to the fire. This embodiment can also be used to fight forest fires by creating an area in the path of the fire that is covered with a layer of solid CO₂, which layer is large enough (both in depth and surface area) to stop the progress of the fire. Similarly, this embodiment can be used to protect a house or other structure that is in the path of a forest fire, but which is not yet on fire, from the approaching fire. To accomplish this, the house or other structure would be covered with solid CO₂ to prevent the structure from catching fire when the fire reaches the structure and burns past it. In essence, the structure is covered with what could be envisioned as a blanket of sold CO₂ that protects the structure from the fire (optionally, in addition to covering the structure with a blanket of CO₂ the structure could also be filled with CO₂). The CO₂ could also be envisioned as forming a wall or mound of solid CO₂ around the structure that is to be protected from an oncoming fire.

The system 1 for generating CO₂ pellets shown in FIG. 1 comprises a vehicle assembly 2, a CO₂ source 14, a pellet generating assembly 30 and a pellet distribution assembly 31.

The vehicle assembly 2 comprises a first engine 3 and a second engine 4. The first engine 3 provides the power to drive and move the vehicle assembly 2. The second engine 4 provides the power to operate the pellet generating assembly 30 and the pellet distribution assembly 31.

These engines can be the same or different, additionally if the first engine is large enough the second engine may not be necessary. Additionally, the second engine may not be necessary if the source of CO₂ has sufficient pressure and volume to provide the power for the pellet generating assembly, as well as, a source of CO₂ for the pellets. If the size and power requirements of the system dictate additional engines may also be used. These engines can be any type of engine or motor that can be used in or for large equipment. For example, and without limitation, these engines can be gasoline engines, diesel engines such are used in heavy equipment for construction purposes. The engines can also be diesel electric or turbine engines. It is noted that in the system of FIG. 1 the system is self-propelled, that is the engine that drives the vehicle is part of the vehicle. Other embodiments where the system is mobile, but is not self propelled, can also be employed, such as for example if the system where on a trailer, in a container, on a rail car or a sled that could be towed carried or moved by some other device.

The vehicle assembly 2 further comprises an operation cab 5, a clearing means 6, several rolling means 7, a fuel tank 8, an articulation means 9, a compressor 10, and a heater 11. The operation cab 5 may be similar to a conventional truck or heavy equipment cab in which an operator sits. This type of cab may have protection from heat and objects that may fall on the vehicle. This type of cab may also have roll over protection. The operation cab may also be a remote control site-that is the operator is at a location away from the vehicle (a few feet to potentially miles away) and operates the vehicle, the pellet generating assembly, and the pellet distribution assembly by remote control.

The entire system 1 may have controllers; computers and other types of automation related equipment to control and regulate the operation of the system. It is contemplated that the controllers may be such that the system can be operated entirely by remote control. Thus, this remote control capability will permit the system to be positioned in close proximity to a fire, without placing the lives of its operators at risk. Accordingly, the system may require personnel to operate it, much like a conventional fire truck requires firemen to operate, or may have some degree of automation, or may further be able to be operated completely by remote control.

The clearing means 6 may be a blade, such as the blade used with bulldozers, it may be a bucket such as the types of buckets used with front-end loaders, or it could be any other type of attachment that is known to be used to attach to equipment to move lift or clear objects from their path.

The rolling means 7 may be wheels, all of which may be driven, or drive wheels, or only some of which may be driven. Examples of such wheels are those that are used on large heavy equipment. The rolling means may also be track and wheel assemblies.

The fuel tanks 8 may be any type of fuel tank that is used on heavy equipment. The fuel tanks should be protected from heat and fire. A single or multiple fuel tanks may be used and the tanks may be positioned any where on the vehicle that is safe and advantages for the purposes of the vehicle.

An articulation means 9 may be present. For example an articulation means such as is used on heavy equipment, which permits the vehicle to bend but transmits power to the wheels on either side of the articulation means may be used. The articulation means may be present when the length of the vehicle is such that it would be useful to have an articulation means or when the articulation means would be beneficial to the movement of the vehicle, e.g., by providing a better turning radius or providing better traction capabilities. The articulation means may serve as the sole source of steering for the vehicle. The rolling means may also be a source of steering for the vehicle.

A compressor 10 and a heater 11 may also be present on the vehicle. The compressor would provide compressed air that could than be heated by the heater, if need be, to supply warn air to the pellet generating assembly and the pellet distribution assembly. The warm air may be needed to de-ice, or prevent parts of those assemblies from freezing or clogging. The supply of warm air to these assemblies would be provided by and controlled by lines and values, such as line 12 and valve 13 and line 24. Additional heating lines may also be employed. Moreover, heaters, or heating tape may be employed to prevent components of the system from freezing or icing up.

The CO₂ 14 source may be a tank of compressed CO₂ that is mounted on the vehicle. The larger the amount of CO₂ in the tank the greater the amount of CO₂ pellets that can be made and the longer the system can be used to fight, prevent, or stop fires before having to obtain more CO₂. The source of CO₂ is under pressure. For example, the pressure in the CO₂ tank may be about 2,000 lbs/sq. in (psi), or may be greater or it may be lower. As shown on the chart in FIG. 4, the pressure in the tank should be great enough so that when the pressure is released the CO₂ cools and changes to a solid.

The 2 source may also be a continuous source, such as from a pipeline or hose that is contented to a much larger distribution source of CO₂. Thus, the system could operate as a self-contained batch system, i.e., it carries the CO₂ need with it and when that source is depleted it must be refilled; a semi-batch system, i.e., a source to refill the CO₂ source is connected to the system at the location of use; or a continuous system, i.e., the source of CO₂ is connected to or feed from a source of substantially larger amounts of CO₂, such as by pipeline or feed line. The CO₂ source 14 is connected to the pellet generating assembly by valves and lines, such as by line 15 and valve 16.

The pellet generating assembly 30 comprises a chamber 17, in which the CO₂ gas is cooled and transitioned from a gas to a solid. This solid CO₂, which is in a very low-density snow like form. The density of this low-density solid CO₂ is than increased, i.e., it is made denser, by the densifier 18.

FIG. 2 is a block diagram showing generally a solid CO₂ generating assembly 130. That assembly comprises a source of CO₂ 115, a first chamber 117 to form solid CO₂, a second chamber 118 to increase the density of the solid CO₂ and a third chamber 120 that is used to move the dense CO₂ from the assembly. It is noted that the functions of the three chambers can be combined into a single chamber or may be subdivided into even more chambers. In is further noted that the chambers may reside in a single apparatus or assemble or that they may reside in separate assemblies. The third chamber by way of example could be a conveyor, or a mixing chamber that mixes the dense CO₂ with a carrying gas, such as CO₂ or air. Examples of such assemblies are found in U.S. Pat. No. 4,389,820, U.S. Pat. No. 5,651,737 and U.S. Pat. No. 5,520,572, the disclosures of which are incorporated herein by reference.

Referring again to FIG. 1, the solid CO₂ than passes through value 19 to inline connector 20 where it is mixed with a carrier gas, in this embodiment CO₂ from source 14, which carrier gas is carried through line 21 and value 22 to inline connector 20. The inline connector 20 may be a mixing device, such a venturi type device. Heated gas may also be available to these components from line 24. The solid CO₂ and carrier gas than move through line 23 to the pellet distribution assembly 31.

The densified CO₂ may be in any form that is convenient to distribute to the fire. Thus it may be in the form of pellets (from rice sized to several inches), balls, bricks or other shapes and forms. The shape or form of the CO₂ may also be changed after it is made and before being used. Thus, larger blocks of CO₂ could be subsequently ground into smaller particles for use.

The density of the solid CO₂ should be such as to take into consider one or more factors such at that it can be propelled toward the fire, cover or fill an article and reside for a time at ambient conditions before the heat of a fire approaches, as well as, reside for a time as the heat of the fire approaches. By way of illustration and without limitation the CO₂ pellets used in a system, such as show in FIG. 1, should be great enough that they can be propelled from the distributor 29 and travel a distance to the fire. Increases in density can have a positive effect on the ability to propel an article such as the pellets, both with respect to the distance that the article can be propelled and with respect to the accuracy with which the article can be propelled.

By way of teaching illustration (the applicant does not intended to be bound by these theories) the common sense example throwing a loosely wadded ball of paper the size of a baseball—lower density, and a real baseball—higher density shows that an increase in density can also result in an increase in the ability to propel the article, both from distance and accuracy standpoints.

The increase in density is also advantages because with an increase in density the solid CO₂ will be less affected by the winds and airflow that accompany a fire, especially a large fire. Again by way of teaching illustration and without being bound to this theory, the common sense example of the paper ball and the real baseball is instructive. It will take substantially greater wind forces to move the real baseball than the paper ball. Moreover, the real baseball can be thrown with greater accuracy on a windy day than can the paper ball.

In general the sold CO₂ as used in the various embodiments and implementations of the invention should be dense. The appropriate density will depend on the conductions and equipment that are being used and thus may vary from situation to situation. The density of the solid CO₂ may be from 0.5 pounds per cubic foot to the maximum density that can be obtained. Thus, the solid CO₂ may be low density-from about 1 to about 20 pounds per cubic foot. By use of the term “about” applicant means a variation of 0-10%. Thus “about 1” would include the value of 0.9 to 1.10. The solid CO₂ may be middle density-from about 20 pounds per cubic foot to about 50 pounds per cubic foot. The solid CO₂ may be high density-greater than about 50 pounds per cubic foot.

Referring again to FIG. 1, the pellet distribution assembly 31 has a distributor 29 that may be mounted an articulated boom assembly comprising a base 25, a rotating base 26, a pivot 27, and an extendable boom 28. The pellet distribution assembly 31 provides the ability to position the distributor 29 in a wide variety of positions, heights, and distances to the point of application for the solid CO₂. The distributor 29 can be a pipe or tube or can be a more complex having the capability to regulate the type of stream that is propelled from the distributor. In addition the distributor 29 may comprise some or all of the elements of the pellet generating assembly 30.

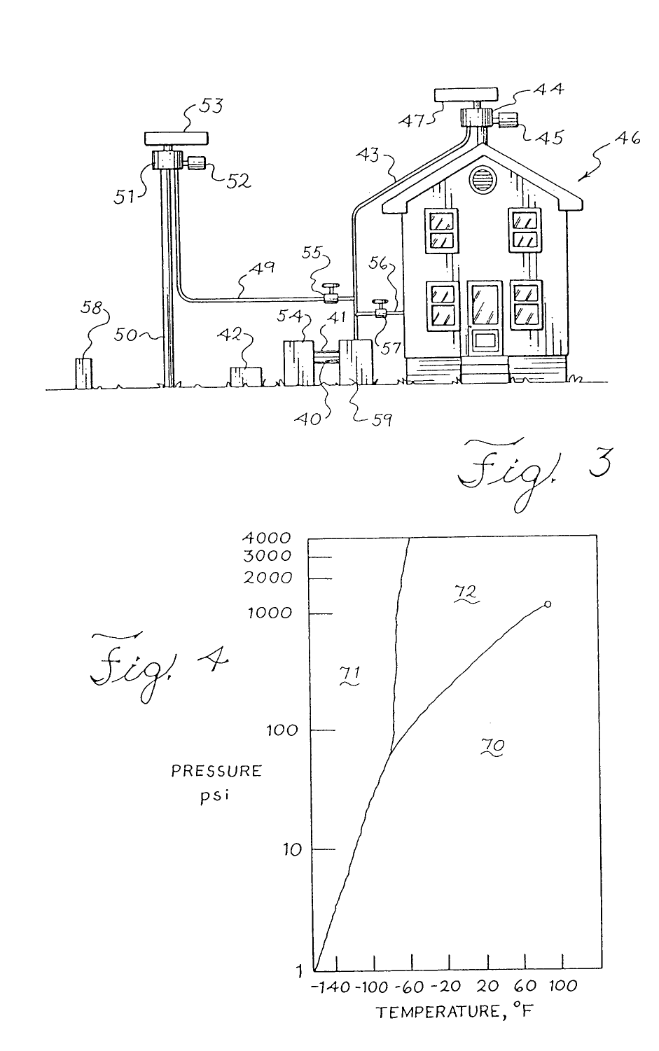

Referring now to FIG. 3, there is provided an example of a system implementing the present invention. In this example the invention is configured to protect a house 46 and its nearby property from a wild fire (forest fire, brush fire, or similar type of fire that begins outside of the structure to be protected). This system comprises a CO₂ source 54 and a pellet generating assembly 59. The pellet generating assemble 59 and the CO₂ sources 54 are as described above regarding FIGS. 1 and 2. The CO₂ source 54 is connected to the pellet generating assembly 59 by line 40, a line 41 may also be used to carry warming gas. Additional valves and warming lines may also be employed as needed in any of the implementations of this invention and are not shown in the drawing herein. A source of power 42 may also be used with this system. The source of power can be for example a generator, compressed air cylinders, or compressor. It can be used to supply warming air, compressed air, or electrical power to drive and operate any of the components of the system.

The densified CO₂ is transported through line 43 to distributor 47. Distributor 47 may be mounted on an articulation joint 44 and a drive 45. In this way the distributor can be moved and positioned to cover the entire roof of the house, as well as, the nearby ground, with solid CO₂. The distributor can also be positioned to direct sold CO₂ to a particular point on the roof or nearby ground.

The system may also comprise addition components for example a support 50, which may be for example a metal pole, a second distributor 53, mounted on the support and also having its own articulation joint 51 and drive 52. In this way several distributors may be positioned around a particular area, or structure to provide a wider area that can be covered with solid CO₂.

The distributor 53 is provided with densified CO₂ through line 49 and valve 55 which is connected to line 43. An additional valve 57 and line 56 may also be employed to provide densified CO₂ to the interior of the house or structure. Additionally a sensor 58 may be used to detect a rise in temperature that would automatically start the system to cover the desired structure and area with solid CO₂. Lines carrying warming gas, or other means of warming the valves, lines, and joints, such as heated tape, may be employed throughout the system as needed and are not expressly shown in the drawings. Moreover, several distributors, pellet generating assemblies and sensors can be employed to provide the desired amount of coverage for a particular area and structures. The system of Figure two may also have computes and controllers that operate and control the system. These devices may provide for completely automated control of the systems, for example in situations where the house or structure has been evacuated.

In practice, by way of example, a house would have a CO₂ source and a pellet generating assembly located near house. A distributor would be located on the roof of the house and six distributors would be located around the house on supports. Sensors would be located around the house and further away from the house than the support based distributors. At the point where the sensor detect a raise in temperature, sufficient to indicate the approach of an oncoming fire, the system begins to generate and distribute densified CO₂ to cover the roof of the house and the surrounding ground near to the house. In this way the structure and surround ground would be blanketed in CO₂. As the fire approaches the blanket of CO₂ would protect the house from fire, both by its cooling effect and by the fact that the CO₂ when sublimated to its gaseous form would deprive the fire of oxygen. The house itself may also be filled with densified CO₂. This would further cool and protect the house from the fire. Moreover, and significantly, because the densified CO₂ will sublimate directly to a gas, and thus not leave any residue, the house and its contents will not be damaged by the use of the CO₂ to prevent the fire.

The vehicle of FIG. 1 may also have a modified distributor that provides the capability to be inserted into a widow or door of a structure on fire or at risk of catching on fire, with densified CO₂. Systems using the present invention may also be built into large containers that can than be stored thorough out a large geographic area that is at risk of fires and than quickly deployed to the particular area or areas where the systems are needed. Larger and more complex embodiments of the system as illustrated in FIG. 2 may also be employed to protect a collection of structures such a town or city. Additionally, the system may also be fitted into an aircraft to permit the distribution of solid CO₂ from the air.

The fire fighting and prevention systems may also be incorporated into a modular system comprising a mobile CO₂ generating system and systems such as illustrated in FIGS. 1 and 2. In this way the equipment necessary to generate a source of CO₂ for use with the systems as illustrated in FIGS. 1 and 2 can be located near the property or structures to be protected, or near the fire to be extinguished.

1. A mobile fire fighting system comprising:
a frame;
an operations cab attached to the frame;
a CO₂ source attached to the frame, the CO₂ source providing at least about 10,000 pounds of liquid CO₂;
a pellet generating assembly attached to the frame;
a first line connecting the CO₂ source to the pellet generating assembly;
a pellet distribution assembly attached to the frame;
and a second line connecting the pellet distribution assembly to the pellet generating assembly;
whereby, the system is capable of generating and distributing densified CO₂ to prevent or extinguish fires.

2. A mobile fire fighting vehicle comprising:
a base;
an engine;
an operations cab;
a plurality of rolling means;
a fuel tank;
the engine, operations cab, rolling means and fuel tanks being attached to the base;
a CO₂ source;
a first chamber;
a pellet densifier;
a pivot;
a boom;
a pellet distributor;
the CO₂ source being operationally connected to the first chamber, the first chamber being operationally connected to the pellet densifier, the pellet densifier being operationally connected to the pellet distributor; and
the pellet distributor being positioned on the boom, the boom being affixed to the base through the pivot.

3. A fire fighting system comprising:
a CO₂ source;
a pellet generating assembly;
the pellet generating assembly capable of generating solid densified CO₂ pellets;
a pellet distributor; and,
the pellet distributor capable of distributing the solid densified CO₂ pellets at a location;
whereby the system is capable of generating and distributing a blanket of CO₂ pellets to cover the location.

4. A fire fighting system for protecting a structure from fire comprising:
a CO₂ source capable of holding at least about 10,000 pounds of CO₂;
a pellet generating assembly;
the pellet generating assembly capable of generating solid densified CO₂ pellets;
a plurality of pellet distributors, the pellet distributor capable of distributing the solid densified CO₂ pellets;
at least one of the pellet distributors attached to a support;
at least one of the pellet distributors attached to the structure;
whereby the system is capable of generating and distributing a blanket of CO₂ pellets to cover the structure and location adjacent to the structure with a blanket of solid CO₂ pellets.

5. A fire fighting system comprising:
a CO₂ source;
a pellet generating assembly;
the pellet generating assembly capable of generating solid densified CO₂ pellets;
a pellet distributor; and,
the pellet distributor capable of distributing the solid densified CO₂ pellets at a location;
a sensor, the sensor capable of detecting a fire and operationally associated with the system to activate the system upon detection of a fire;
whereby the system is capable of generating and distributing a blanket of CO₂ pellets to cover the location upon detection of a fire by the sensor.
